(19) United States
(12) Patent Application Publication
(10) Pub. No.: US 2020/0021942 A1
(43) Pub. Date: Jan. 16, 2020

(54) ASSISTANCE SYSTEM FOR VISITOR MANAGEMENT

(71) Applicant: Siemens Schweiz AG, Zürich (CH)

(72) Inventor: Christian Frey, Unterägeri (CH)

(73) Assignee: Siemens Schweiz AG, Zürich (CH)

(21) Appl. No.: 16/506,026

(22) Filed: Jul. 9, 2019

(30) Foreign Application Priority Data
Jul. 11, 2018 (DE) 10 2018 211 481.1

(51) Int. Cl. H04W 4/02; H04L 29/08; H04W 4/33; H04W 4/21; H04M 1/725; G06Q 10/06

(52) U.S. Cl. CPC H04W 4/023; H04L 67/10; H04W 4/33; G06Q 10/06315; H04L 67/327; H04M 1/72525; H04M 1/72572; H04W 4/21

(57) ABSTRACT

A system and/or method for assisting individuals in a building, including locating first and second mobile devices using a position determining system. The first mobile device is uniquely associated with an individual. The second mobile device is uniquely associated with a service technician. A server communicates with the position determining system, the first mobile device, and the second mobile devices. The server generates, an importance ranking in relation to a request from the first mobile device. The server, on the basis of the importance ranking of the request, the position of the first mobile device, and the position of the second mobile device, sends a message to the second mobile device for assistance for the individual associated with the respective first mobile device, wherein the message comprises the position of the respective first mobile device.

### CROSS-REFERENCE TO RELATED APPLICATIONS

This application claims priority to DE Application No. 10 2018 211 481.1 filed Jul. 11, 2018, the contents of which are hereby incorporated by reference in their entirety.

### TECHNICAL FIELD

The present disclosure relates to visitor management in a building. Various embodiments include assistance systems, cloud service applications and/or methods for assisting individuals temporarily present in a building.

### BACKGROUND

The automation of assistance systems for visitor management in public buildings or company buildings is currently often only rudimentary or not designed to address the individual needs of visitors, in particular first-time visitors. This often results in visitors taking unnecessary and ineffective routes to their respective objectives. The term visitor also includes workmen or other service providers who have a job to do in the building.

### SUMMARY

The teachings of the present disclosure describe an effective and efficient assistance system for visitor management in buildings. Some embodiments include an assistance system for assisting individuals temporarily present in a building, wherein said assistance system comprises: a position determining system, for locating mobile devices situated in the building; first mobile devices, which are each uniquely associated with a person in the building, wherein the first mobile devices are set up to determine, in cooperation with the position determining system, the current position of one of the first mobile devices, wherein the first mobile devices are further set up to send their current position to a server; second mobile devices, which are each uniquely associated with a service technician in the building or for the respective building, wherein the second mobile devices are set up to determine, in cooperation with the position determining system, the current position of one of the second mobile devices, wherein the second mobile devices are further set up to send their current position to the server; a server, which is set up to communicate for data processing with the position determining system, the first mobile devices and the second mobile devices; wherein the server is further set up to generate, on request from one of the first mobile devices for assistance for the respective individual associated with this first mobile device, an importance ranking, in particular a queue ranking, in relation to the request; wherein the server is further set up, on the basis of the importance ranking of the request, the position of the respective first mobile device sending the request, and the position of a respective second mobile device, to send a message to the respective second mobile device for user-side output, wherein the message comprises the position of the respective first mobile device. The first and second mobile devices may include appropriately set up mobile communication terminals, e.g. smartphones. The corresponding software (app) for the smartphones may for example be downloaded onto the smartphones by internet download. On entering the building, a visitor is advantageously automatically advised to download the software (app), for example by visual and/or acoustic output of a message on the smartphone. A link to download the app may moreover be provided visually at the entrance, e.g., in the form of a QR code.

In some embodiments, the message comprises information for assisting the individual associated with the respective first mobile device, e.g., a task. The message may comprise personalized guidance for assisting the individual associated with the respective first mobile device. The respective personalized guidance may be derived, for a respective individual, from historical data (for example previous visits by the individual) and/or from social media data input by the individual.

Determination of the importance ranking for a request may be based on historical data (for example previous visits by the individual, VIP status) and/or based on social media data input by the individual. Neural networks and/or deep learning methods may be used to determine the importance ranking.

The position determining system for example comprises an indoor position determining system, for example based on beacons (for example iBeacons), Bluetooth, or WLAN.

### BRIEF DESCRIPTION OF THE DRAWINGS

The teachings of the present disclosue and example embodiments thereof are explained by way of example with reference to the following figures, in which:

FIG. 1 shows an exemplary assistance system incorporating teachings of the present disclosure for assisting individuals temporarily present in a building, and

FIG. 2 shows an exemplary flow chart for a method incorporating teachings of the present disclosure for assisting individuals temporarily present in a building.

### DETAILED DESCRIPTION

In some embodiments of the teachings herein the server is set up to send the message for assistance for the individual associated with the respective first mobile device on the basis of the distance between the respective first mobile device and the respective second mobile device. For instance, the free assistants (service personnel) closest to the individual requesting assistance may in each case be instructed. In emergency situations in particular, it is thus possible to provide assistance as quickly as possible.

In some embodiments, a graphical and/or color coding is output on the display of the respective second mobile device on receipt of the respective task, on the basis of the importance ranking of the respective request. For instance, on the basis of the importance ranking of a request, the assistant or member of service personnel who receives the request is able to decide how quickly to go to the assistance of a visitor. Furthermore, an assistant or member of service personnel may work through the requests received on the basis of the importance ranking.

In some embodiments, the server is set up to send confirmation of the respective request to the respective first mobile device. This may proceed automatically. An individual who sends a request thus knows that his or her request is being processed.

In some embodiments, the confirmation comprises a queue rank and/or waiting time relating to processing of the request. For instance, an individual requesting help or assistance is informed as to when this help or assistance can be expected.

In some embodiments, calculation of the waiting time is based on the current service technician workload and on historical data relating to similar requests. The server for example comprises a memory (database) with historical data (for example start time and end time for provision of a service). Furthermore, the server comprises appropriate processing means (processor, software) for calculating the respective waiting time on the basis of the historical data and the current data (e.g. current number of visitors in the building, current number of assistants or service personnel). This may take place using artificial intelligence (AI) methods, e.g. neural networks, decision tables or deep learning algorithms.

In some embodiments, a report is sent to the server via the respective second mobile device on completion of the request. The server may thus close the ticket for the request and assign the assistant or member of service personnel to another request. The server is also set up to detect cancellation of the task or of a request by the individual making the respective request.

In some embodiments, a report is sent to the server via the respective first mobile device about the level of satisfaction related to the respective request. This information may be processed by the server using artificial intelligence (AI) methods, e.g. neural networks or deep learning algorithms. This makes it possible, for example, to identify ways of making the service provision better.

Some embodiments may include a method for assisting individuals temporarily present in a building, wherein first and second mobile devices situated in the building are located using a position determining system; wherein the first mobile devices are each uniquely associated with an individual in the building, wherein the first mobile devices are set up to determine, in cooperation with the position determining system, the respective position of one of the first mobile devices; wherein the second mobile devices are each uniquely associated with a service technician in the building, wherein the second mobile devices are set up to determine, in cooperation with the position determining system, the respective position of one of the second mobile devices; wherein a server is set up to communicate for data processing with the position determining system, the first mobile devices and the second mobile devices; wherein the server is further set up to generate, on request from one of the first mobile devices for assistance for the respective individual associated with this first mobile device, an importance ranking, in particular a queue ranking, in relation to the request; wherein the server is further set up, on the basis of the importance ranking of the request, the position of the respective first mobile device sending the request, and the position of a respective second mobile device, to send a message to the respective second mobile device for assistance for the individual associated with the respective first mobile device, wherein the message comprises the position of the respective first mobile device. The message may comprise directions for assisting the individual associated with the respective first mobile device. The method may be implemented or retrofitted using infrastructure conventionally already present in any case in the building.

Some embodiments include a cloud service application for assisting individuals temporarily present in a building, wherein first and second mobile devices situated in the building are located using a position determining system; wherein the first mobile devices are each uniquely associated with an individual in the building, wherein the first mobile devices are set up to determine, in cooperation with the position determining system, the current position of one of the first mobile devices; wherein the second mobile devices are each uniquely associated with a service technician in the building, wherein the second mobile devices are set up to determine, in cooperation with the position determining system, the current position of one of the second mobile devices; wherein a server, in particular a cloud server, is set up to provide (for example “host”) the cloud service application; wherein the server is set up to communicate for data processing with the position determining system, the first mobile devices and the second mobile devices; wherein the server is further set up to generate, on request from one of the first mobile devices for assistance for the respective individual associated with this first mobile device, an importance ranking, in particular a queue ranking, in relation to the request; wherein the server is further set up, on the basis of the importance ranking of the request, the position of the respective first mobile device sending the request, and the position of a respective second mobile device, to send a message to the respective second mobile device for assistance for the individual associated with the respective first mobile device, wherein the message comprises the position of the respective first mobile device. The message advantageously comprises directions for assisting the individual associated with the respective first mobile device. A cloud service application may be readily implemented in a cloud infrastructure for example as software as a service (SaaS) or as platform as a service (PaaS). The first and second mobile devices (e.g. mobile communication terminals, e.g. smartphones) may be set up with the appropriate software (for example by internet download) for the cloud service application.

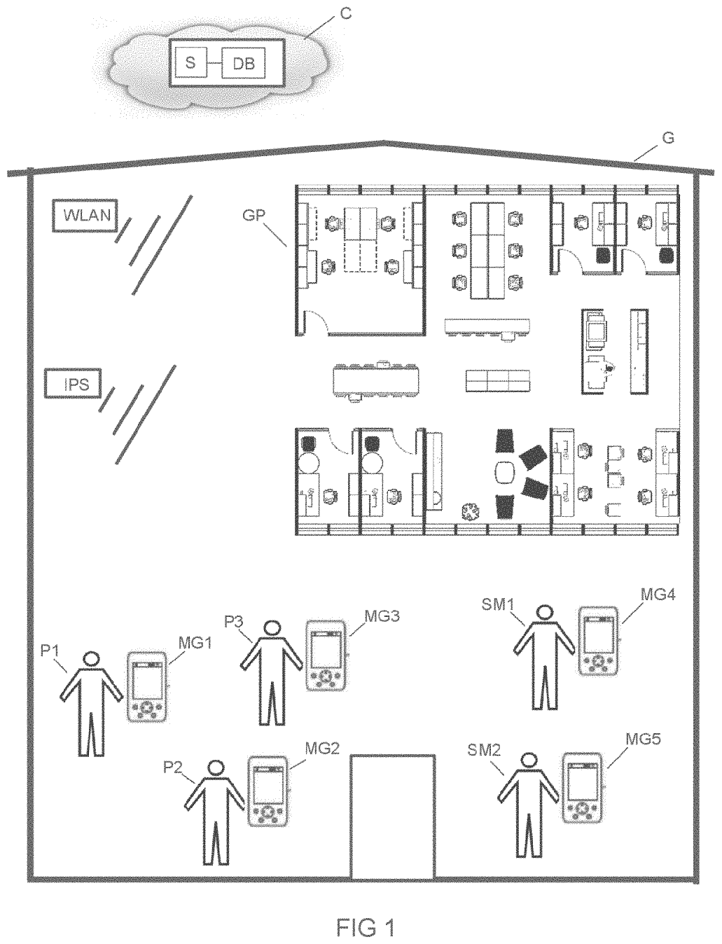

FIG. 1 shows an exemplary assistance system for assisting individuals P1-P3 temporarily present in a building G. The exemplary assistance system comprises: a position determining system IPS, for locating mobile devices MG1-MG5 situated in the building; first mobile devices MG1-MG3, which are each uniquely associated with an individual P1-P3 in the building G, wherein the first mobile devices MG1-MG3 are set up to determine, in cooperation with the position determining system IPS, the current position of one of the first mobile devices MG1-MG3, wherein the first mobile devices MG1-MG3 are further set up to send their current position to a server S; second mobile devices MG4, MG5, which are each uniquely associated with a service technician SM1 in the building G or for the building G, wherein the second mobile devices MG4, MG5 are set up to determine, in cooperation with the position determining system IPS, the current position of one of the second mobile devices MG4, MG5, wherein the second mobile devices MG4, MG5 are further set up to send their current position to the server S; a server S, which is set up to communicate for data processing with the position determining system IPS, the first mobile devices MG1-MG3 and the second mobile devices MG4, MG5; wherein the server S is further set up to generate, on request from one of the first mobile devices MG1-MG3 for assistance for the respective individual P1-P3 associated with this first mobile device MG1-MG3, an importance ranking, in particular a queue ranking, in relation to the request; wherein the server S is further set up, on the basis of the importance ranking of the request, the position of the respective first mobile device MG1-MG3 sending the request, and the position of a respective second mobile device MG4, MG5, to send a message to the respective second mobile device MG4, MG5 for user-side output, wherein the message comprises the position of the respective first mobile device MG1-MG3.

The individuals P1-P3 may be referred to the assistance system present in the building G or to the services of the assistance system when they enter the building G. If the position determining system IPS identifies a new mobile device MG1-MG3 in the building G, a message may for example be sent to this mobile device with a reference to the assistance system. An individual P1-P3 may register with the assistance system and the server for example via a corresponding acknowledgment (for example by activation of a URL address link). By activating the link, it is possible, for example, also to download a corresponding app (for example for communicating with the assistance system) onto the respective mobile device MG1-MG3.

The position determining system IPS may comprise an indoor position determining system, for example based on WLAN or Bluetooth (e.g. beacons (for example iBeacons) or BLE). In principle, however, a satellite-supported position determining system (for example GPS) may also be used, in particular when using the assistance system in the open air.

The mobile devices MG1-MG5 may include appropriately set up mobile communication terminals (e.g. smartphones, smartwatches). The mobile devices MG1-MG5 have appropriate software (e.g. an app) for communicating with the server and for outputting corresponding information. Appropriately set up proprietary devices could also be used as second mobile devices MG4, MG5 for the members of service personnel SM1, SM2.

The server S may be implemented in a cloud infrastructure C. The services of the assistance system may thus be offered as software as a service (SaaS) or as platform as a service (PaaS) for building operators.

The server S may comprise an appropriately set up computer (e.g. personal computer, workstation) with corresponding hardware (processor, memory, communication interfaces) and software (e.g. AI software, such as neural networks, deep learning programs). The server S may access a database DB (for example a relational database, an object-oriented database or an in-memory database), which comprises historical data from previous requests. Waiting times for specific requests may for example be determined or estimated on the basis of the historical data.

The server S may be further set up to send the message for assistance for the individual P1-P3 associated with the respective first mobile device MG1-MG3 on the basis of the distance between the respective first mobile device MG1-MG3 and the respective second mobile device MG4, MG5. The message may for example be sent as an SMS, via a messaging app or via another suitable service.

A graphical and/or color coding may be output on the display of the respective second mobile device MG4, MG5 on receipt of the respective task, on the basis of the importance ranking of the respective request.

The server S may be set up to send confirmation of the respective request to the respective first mobile device MG1-MG3. In some embodiments, the confirmation comprises a queue rank and/or waiting time relating to processing of the request. In some embodiments, the calculation of the waiting time is based on the current workload of the service technicians and on historical data relating to similar requests. In some embodiments, a report is sent to the server S via the respective second mobile device MG4, MG5 on completion of the request. The server may thereby close the ticket for this request and save the data relating to this request (e.g. time required to deal with the request) in the database DB for historical data.

In some embodiments, a report is sent to the server S via the respective first mobile device MG1-MG3 about the level of satisfaction related to the respective request. For example, the respective individual P1-P3 may communicate his or her level satisfaction to the server S by grading it from 1 to 6 on the display of the respective mobile device MG1-MG3. The AI software on the server S may use this information for subsequent requests. In this way, the services of the assistance system may also be improved.

In some embodiments, the assistance system comprises a cloud service application for assisting individuals temporarily present in a building G, wherein first and second mobile devices MG1-MG5 situated in the building G are located using the position determining system IPS; wherein the first mobile devices MG1-MG3 are each uniquely associated with an individual in the building, wherein the first mobile devices MG1-MG3 are set up to determine, in cooperation with the position determining system, the current position of one of the first mobile devices MG1-MG3; wherein the second mobile devices are each uniquely associated with a service technician SM1-SM2 in the building G, wherein the second mobile devices MG4, MG5 are set up to determine, in cooperation with the position determining system IPS, the current position of one of the second mobile devices MG4, MG5; wherein a server S, in particular a cloud server, is set up to provide the cloud service application; wherein the server S is set up to communicate for data processing with the position determining system, the first mobile devices MG1-MG3 and the second mobile devices MG4, MG5; wherein the server S is further set up to generate, on request from one of the first mobile devices MG1-MG3 for assistance for the respective individual P1-P3 associated with this first mobile device MG1-MG3, an importance ranking, in particular a queue ranking, in relation to the request; wherein the server S is further set up, on the basis of the importance ranking of the request, the position of the respective first mobile device MG1-MG3 sending the request, and the position of a respective second mobile device MG4, MG5, to send a message to the respective second mobile device MG4, MG5 for assistance for the individual P1-P3 associated with the respective first mobile device MG1-MG3, wherein the message comprises the position of the respective first mobile device MG1-MG3.

In some embodiments, the cloud service application is implemented or “hosted” by the server S in the cloud infrastructure C. The services of the assistance system may thus be offered very simply as software as a service (SaaS) or as platform as a service (PaaS) for building operators. The first and second mobile devices (e.g. mobile communication terminals and/or smartphones) may be appropriately set up to communicate with the cloud service application.

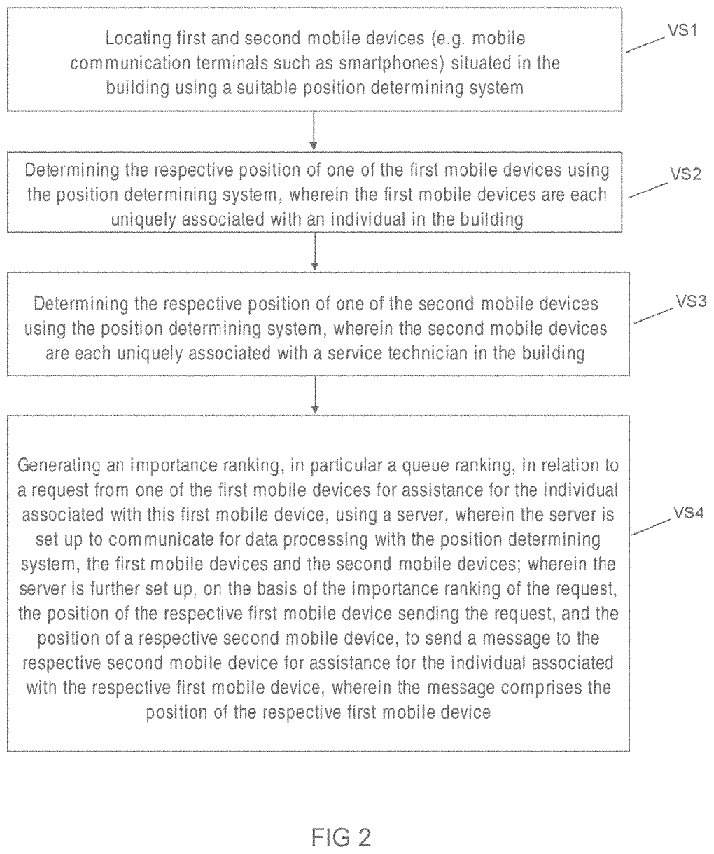

FIG. 2 shows a flow chart for a method for assisting individuals temporarily present in a building. The exemplary method comprises the steps: (VS1) locating first and second mobile devices (e.g. mobile communication terminals such as smartphones) situated in the building using a suitable position determining system; (VS2) determining the respective position of one of the first mobile devices using the position determining system, wherein the first mobile devices are each uniquely associated with an individual in the building; (VS3) determining the respective position of one of the second mobile devices using the position determining system, wherein the second mobile devices are each uniquely associated with a service technician in the building; (VS4) generating an importance ranking, in particular a queue ranking, in relation to a request from one of the first mobile devices for assistance for the individual associated with this first mobile device, using a server, wherein the server is set up to communicate for data processing with the position determining system, the first mobile devices and the second mobile devices; wherein the server is further set up, on the basis of the importance ranking of the request, the position of the respective first mobile device sending the request, and the position of a respective second mobile device, to send a message to the respective second mobile device for assistance for the individual associated with the respective first mobile device, wherein the message comprises the position of the respective first mobile device. The method can be readily implemented or retrofitted using infrastructure already present in any case in buildings.

In some embodiments, the position determining system comprises an indoor position determining system, for example based on WLAN or Bluetooth (e.g. beacons or BLE). In principle, however, a satellite-supported position determining system (for example GPS) may also be used.

In some embodiments, the mobile devices are appropriately set up mobile communication terminals (e.g. smartphones, smartwatches). The mobile devices have appropriate software (e.g. an app) for communication with the server and for outputting corresponding information. Appropriately set up proprietary devices could also be used as second mobile devices for the members of service personnel. In some embodiments, the server is implemented in a cloud infrastructure. The services of the assistance system may thus be offered as software as a service (SaaS) or as platform as a service (PaaS) for building operators.

### REFERENCE CHARACTERS

S Server
DB Database
C Cloud
G Building
GP Building plan
IPS Position determining system
WLAN Communication system
P1-P3 Individual
SM1, SM2 Service technician
MG1-MG5 Mobile device
VS1-VS4 Method step

1. An assistance system for assisting individuals temporarily present in a building, the assistance system comprising:
a position determining system for locating mobile devices situated in the building;
a first set of mobile devices each uniquely associated with an individual in the building, wherein a mobile device in the first set of mobile devices determines, in cooperation with the position determining system, a respective current position and sends the respective current position to a server;
a second set of mobile devices each uniquely associated with a service technician, wherein a mobile device in the second set of mobile devices determines, in cooperation with the position determining system, a respective current position and sends the respective current position to the server;
a server to communicate with the position determining system, the first set of mobile devices, and the second set of mobile devices;
wherein the server generates, in response to a request from one of the first mobile devices for assistance, an importance ranking associated with the request;
wherein the server, on the basis of the importance ranking of the request, determines the position of the respective first mobile device sending the request, and the position of a respective second mobile device, to send a message to the respective second mobile device for user-side output, wherein the message comprises the position of the respective first mobile device.

2. The assistance system as claimed in claim 1, wherein the server sends the message for assistance on the basis of the distance between the respective first mobile device and the respective second mobile device.

3. The assistance system as claimed in claim 1, wherein a graphical and/or color coding is output on the display of the respective second mobile device on receipt of the respective task, on the basis of the importance ranking of the respective request.

4. The assistance system as claimed in claim 1, wherein the server sends confirmation of the respective request to the respective first mobile device.

5. The assistance system as claimed in claim 4, wherein the confirmation comprises a queue rank and/or waiting time relating to processing of the request.

6. The assistance system as claimed in claim 5, wherein calculation of the waiting time is based on the current workload of the service technicians and on historical data relating to similar requests.

7. The assistance system as claimed in claim 1, wherein a report is sent to the server via the respective second mobile device on completion of the request.

8. The assistance system as claimed in claim 1, wherein a report is sent to the server via the respective first mobile device about the level of satisfaction related to the respective request.

9. A method for assisting individuals temporarily present in a building, the method comprising:
locating a first mobile device and a second mobile device situated in the building using a position determining system, wherein the first mobile belongs to a first set of mobile devices each uniquely associated with an individual, wherein the second mobile device belongs to a second set of mobile devices each uniquely associated with a service technician;
communicating between a server set up for data processing with the position determining system, the first mobile devices, and the second mobile devices;
generating using the server, in response to a request from the first mobile device for assistance for the respective individual, an importance ranking in relation to the request;
sending a message from the server, on the basis of the importance ranking of the request, the position of the respective first mobile device sending the request, and the position of the respective second mobile device, to the respective second mobile device for assistance for the individual, wherein the message comprises the position of the respective first mobile device.

10. A cloud service application for assisting individuals temporarily present in a building, the application comprising a set of instructions stored in a memory of a server, the instructions, when accessed and executed by a processor, causing the processor to:
locate a first mobile device and a second mobile device situated in the building using a position determining system, wherein the first mobile device belongs to a first set of mobile devices each uniquely associated with an individual, wherein the second mobile device belongs to a second set of mobile devices each uniquely associated with a service technician;
using the server to communicate for data processing with the position determining system, the first mobile device, and the second mobile device;
generating using the server, in response to a request from the first mobile device for assistance, an importance ranking in relation to the request;
sending a message from the server, on the basis of the importance ranking of the request, the position of the first mobile device sending the request, and the position of the second mobile device, to the second mobile device for assistance for the individual associated with the respective first mobile device, wherein the message comprises the position of the first mobile device.
